(19) United States
(12) Patent Application Publication
(10) Pub. No.: US 2014/0257893 A1
(43) Pub. Date: Sep. 11, 2014

(54) Method and System for Certification

(71) Applicant: Gerard Nicol, Aurora, CO (US)

(72) Inventor: Gerard Nicol, Aurora, CO (US)

(21) Appl. No.: 13/791,626

(22) Filed: Mar. 8, 2013

(51) Int. Cl. G06Q 10/08

(52) U.S. Cl. CPC G06Q 10/087
USPC 705/7.13; 705/28

(57) ABSTRACT

A computer-implemented method and system for receiving an identifier of a transferred item from an asset database of an owner of the item, updating an inventory tracking database of a certification management system to include the transferred item, receiving a representation of compliance that the transferred item is held by a custodian from a custodian inventory management system, generating a certificate for the item indicating that the item is held by the custodian, in response to receiving the representation of compliance, and distributing the certificate to the owner and the custodian of the transferred item.

### BACKGROUND

1. Field

The embodiments of the invention as illustrated and described herein are related to a software managed certification process to enable businesses to track the location of important documents, data and other items, and establish a reliable chain of responsibility between the owners and custodians of the items.

2. Background

Businesses generate large numbers of documents, data, and other items that are important for business, regulatory, tax and legal purposes. These items can be important for audits, accounting, and contractual obligations with customers and other businesses. For these reasons the businesses must closely track and safeguard the items to ensure they have done due diligence in performing their contracts or meeting their regulatory and legal obligations. In some cases, the items are transferred to another business or within the business such that the responsibilities in safeguarding the items are shifted. In these scenarios, an item can be lost or misplaced and each business or department within the business needs to ascertain how and when the item was lost and the responsible party. Similarly, the business may need to verify that contractual or legal obligations were met on a specific time, day or date.

Only informal processes are available to the owner to ensure that an item has been successfully transferred to a particular custodian. The owner can request confirming correspondence from the custodian such as an email that an item has been received. However, if a custodian does not in fact receive the item or even if the item is received it may not be properly recorded, and also the item may be lost or destroyed while in the possession of the custodian. The loss of the item in these cases may not become known until the owner requests the return of the item or access to the item. At that time, the custodian searches for the item and is unable to find the item. In some cases, the item is at that time determined lost, but it is unknown how long the item was lost or whether it was actually received by the custodian. In other cases, the custodian disputes that the item was received, asserts that it had been returned or similarly denies responsibility for the loss of the item. The owner and custodian must then enter into arbitration or litigation to resolve responsibility for the loss of the item, which is a costly and prolonged process.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a flowchart of one embodiment of a certification process.

FIG. 2 is a diagram of one embodiment of a certification system including a certification manager.

FIG. 3 is a diagram of embodiment of the computer system implementing the certification manager.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The operations depicted in the flow diagrams in the attached Figures will be described with reference to the exemplary embodiments shown in the attached Figures. However, it should be understood that the operations depicted in the flow diagrams can be performed by embodiments of the invention other than those discussed with reference to the attached Figures, and the embodiments discussed with reference to the diagrams in the attached Figures can perform operations different than those discussed with reference to the flow diagrams of the attached Figures.

The techniques shown in the figures can be implemented using code and data stored and executed on one or more electronic devices (e.g., an end station, a network element, etc.). Such electronic devices store and communicate (internally and/or with other electronic devices over a network) code and data using non-transitory machine-readable or computer-readable media, such as non-transitory machine-readable or computer-readable storage media (e.g., magnetic disks; optical disks; random access memory; read only memory; flash memory devices; and phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices, user input/output devices (e.g., a keyboard, a touch screen, and/or a display), and network connections. A ‘set,’ as used herein, refers to any positive whole number of items. The coupling of the set of processors and other components is typically through one or more busses and bridges (also termed as bus controllers). The storage devices represent one or more non-transitory machine-readable or computer-readable storage media and non-transitory machine-readable or computer-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

As used herein, a network element (e.g., a router, switch, bridge, etc.) is a piece of networking equipment, including hardware and software, that communicatively interconnects other equipment on the network (e.g., other network elements, end stations, etc.). A server, as used herein, is a computing device having any number of processing elements, memory devices, storage devices, networking elements and similar components that function to offer a resource or service to local or remote computing devices. A remote computing device is a computing device connected to the server over a wide area network. A local computing device is a computing device connected to the server over a local area network or directly connected to the server with a point to point link. The terms “function” and “procedure” are used herein interchangeably and generally refer to a computer-implemented process defined in a computer program.

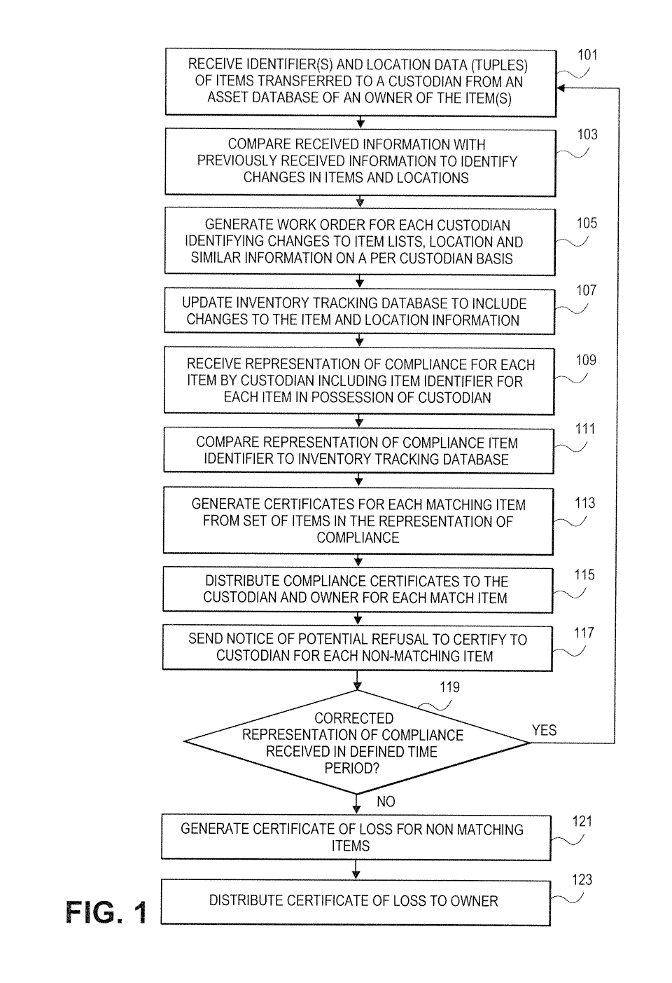

FIG. 1 is a flowchart of one embodiment of a compilation process. In one embodiment, the process can be initiated by an owner of an item to be tracked. The owner can be a company, individual, or any other entity capable of possessing items that require tracking. The items to be tracked can be any type of physical item, such as physical documents, devices, personal possessions, equipment, biological specimens (e.g., organs, body parts, microbes, cultures, DNA samples and similar biological) and other portable objects. Similarly, the item can be any type of electronic item, such as any type of data set, software, digital documents and similar recorded information. In further embodiments, the item can be any serializable or enumerable item (both real or electronic) that can be transferred, identified and tracked. The owner can have any number of items to be tracked. For sake of clarity, examples are discussed of a single item being tracked, however one skilled in the art would understand that the process can be used to track any number of items and that the system would be capable of tracking large numbers of items.

The tracking of the items is part of a certification process, whereby a third party certifier operating a certification management server receives item tracking information, such as item transfer information, and receives representations from a custodian, i.e., a receiver of the transferred item, that the custodian has received the transferred item and is in possession of the item. The representation can also encompass additional characteristics or terms of the custodianship of the item, such as condition, specific location, functionality and similar information related to the item. The additional terms and conditions can vary from item to item as agreed upon between the item owner and the custodian. The third party certifier can receive these additional terms and conditions along with the item transfer information from the owner. In other embodiments, additional terms and conditions can be obtained through other mechanisms and from other parties including the custodian. Any number of additional terms and conditions can be specified from any number of sources. In each case, the representations from the custodian regarding these obligations define whether the terms and conditions are met such that the requirements for compliance with the terms and conditions are met.

A custodian can be any entity capable of controlling or caretaking the item. The custodian can be an individual, company or similar entity, such as a storage or data protection company. The custodian can take responsibility for physical storage of the items, such as a warehouse or can take responsibility for data preservation or backup in a data center or similar facility. The custodian can be a discrete separate party from the owner or can be a commonly controlled or related entity, such as a separate sub-division, department, or similar component of a larger legal entity. The custodian and owner can both be separate from the third party certifier. In other embodiments, the certification process can be controlled and implemented by either the owner or the custodian (i.e., the owner and/or the custodian can control the certification management server). The custodian can care take items for any number of owners and can work in conjunction with any number of certifiers.

The representations of compliance from the custodian are compared with the terms and conditions tracked by the third party certifier. If these representations match the requirements of the terms and conditions, then the third party certifier can issue a certification that the custodian is in compliance with the terms and conditions and that the related item is in the possession of the custodian or at the designated local controlled by the custodian. This system thereby places the onus of compliance and caretaking of the item on the custodian and provides a mechanism for more accurate tracking of the condition and state of the item. The custodian is asked to provide the representations of compliance on a daily basis or at a similar interval. Failure to provide the representation automatically results in the third party certifier denying a certification to the custodian and can generate a certificate of loss or “death certification” indicating that the item is lost or the terms and conditions of its caretaking have been violated.

In one embodiment, this process can be initiated by the owner sending information identifying items that are being transferred (Block 101). The owner can track items internally using an asset database that is managed by an asset management system or similar item tracking software. The asset management system can be in communication over a network with the certification management system and/or the custodian inventory management system. The asset management system or similar software can communicate a listing of items and related data to the certification management server using any protocol or format over any communication medium. Additional data can include location information, identifying the location to which the item is being transferred, such as a custodian or more specifically a location or facility managed by the custodian. The item and location data can be structured as a tuple or pairing of related information in a normalized or specialized format. The additional terms and conditions of the handling of the items can also be associated with the item identifier and location information.

The certification management system can execute a certification manager including an aggregator that receives the item identification and location data, as well as the related data and compiles it for storage in an inventory tracking database. The incoming data can be compared with previously received data from the owner to determine whether changes in item status or new items are listed in the data provided by the owner (Block 103). The owner may provide a complete list of all items being transferred and/or that have already been transferred and are still being handled by the custodian and therefore in need of updated certification. In other embodiments, the asset database and asset management system send only changes in the items status rather than the entire list of items and the associated data.

The changes that are identified by the comparison of the received data with previously received data from the asset management system or that are directly provided by the asset management system can then be utilized to generate a work order by the certification manager (Block 105). A work order (also known as a “picking and distribution list”) is a listing of items on a per custodian basis that the respective custodian is indicated by the owner as having possession or responsibility for the items. In other words, the work order identifies items that have moved or are moving from one location to another, from the control or possession of the owner to the control or possession of the custodian, from the control or possession of the custodian to the control or possession of the owner or similar changes in their condition or contract have occurred. The work order can be an electronic message, document or similar data structure. The work order can be generated by a work order manager of the certification manager. The work order contents are generated by the comparison of the incoming item information with the previously received item information in the inventory tracking database of the certification management server. In situations where no changes have occurred since the last work order was generated, the new work order may be blank or no work order is generated. The work orders can have any format or organization and can be transmitted to the custodian inventory management system using any protocol or medium. Work orders can be generated in response to item and location information that is received from the asset management system, or the work orders can be generated at regular intervals.

Subsequently or at the same time that the work order is generated, the inventory tracking database can be updated to include the newly received information from the asset management system (Block 107). This information can later be utilized to check whether the custodian has reported compliance for all of the items the inventory tracking database indicates are the responsibility of the custodian to see if the representations of compliance later received from the custodian match the expected list of items in the control or possession of the custodian. The certification manager then awaits receipt of the compliance information from the custodian inventory management system. The custodian inventory management system uses the work order to update its inventory database or to compare with its inventory database as directed by the inventory manager. The work order can be the primary mechanism for the custodian inventory management system to receive information about received items, or the information can be separately provided to the custodian inventory management system by the asset management server of the owners.

A certification compliance manager of the custodian inventory management system can manage or guide the check for compliance by the custodian. The compliance determination process can be either a manual or automated process. A manual process can be guided by the certification compliance manager. An automated process can be executed or facilitated by the certification compliance manager. The certification compliance process can be carried out in any manner or organized in any manner to determine whether the specified requirements of the caretaking of each object are met. The compliance with each term of the requirements can be carried out either manually or automatically and the compliance can be tracked by the certification compliance manager using data in the inventory database of the custodian inventory management system. The inventory database includes the item, location and associated information specified in each received work order.

If the certification compliance manager determines that each of the elements of the terms for an item are met and that the item is in the defined location, then the certification compliance manager generates a certification compliance message or document that can be returned to the certification management server. Thus, the certification management system receives this certification compliance message or document, which is a positive representation of compliance for each identified item including an item identifier for each item confirmed to be in the possession of the custodian (Block 109).

In other embodiments, the certification compliance manager of the custodian can provide additional information beyond an item by item representation of compliance. For example, the certification compliance manager can determine that: (1) all items entrusted to the custodian are in compliance and not additional items of the owner or any owner are in the possession of the custodian, (2) all items entrusted to the custodian are in compliance, but additional items of the owner, other owner or unknown owner are in the possession of the custodian, (3) less than all of the items entrusted to custodian are in compliance, but no additional items of the owner, other owner or unknown owner are in the possession of the custodian, (4) less than all of the items entrusted to the custodian are in compliance and additional items of the owner, other owner or unknown owner are in the possession of the custodian or similar variation on these scenarios has been determined.

The representation of compliance is then returned to the certification management server where it is compared against the inventory tracking database (Block 111) to ensure that the custodian has accurately and completely represented that all aspects of the requirements and terms of the caretaking of an item have been met. This comparison can be conducted on an item by item basis using the item identifiers or the item and location tuples or related information. In embodiments where additional scenarios are identified, the various scenarios can be scored or ranked such that any set of the scenarios can be considered in compliance or failing to be in compliance as agreed upon by the owner, custodian and certifier.

Where all of the terms have been represented as being met or a minimum set of the terms has been met, then the certificate generator of the certification manager generates a new certificate for the associated item (Block 113). Thus, each item in a work order or any subset of these items can be identified in the representation of compliance that is returned to the certification management server. Where the work order only identifies changes to the set of items, the representation of compliance may include additional identifiers for the items that have been sent in previous work orders and that are still in the care of the custodian. Full compliance can be required in owner and custodian agreements where it is imperative to immediately identify and fix failures, whereas partial or degrees of compliance can be utilized where the compliance is utilized as a measure of performance for the custodian.

A certificate can be issued for proper compliance that is designated for the owner, custodian or both. The certificate can take any form or format and represents verification that the item is in the possession of the custodian, in a designated location, and meets the terms and conditions specified between the owner and custodian for the care of the item and any ancillary matters. The certificates can be distributed to the owner, custodian or any other designated party (Block 115) or any combination thereof by the certificate generator using any means of communication or conveyance. The certificate can be digitally signed by the entity providing the certification process using a digital certificate issued by a separate certification agency. This enables the certificate to be authenticated at any time in the future and prevents the modification of the certificate after signing and the separate certification agency can authenticate the identity of the entity providing the primary certification process.

In one embodiment, a certificate of loss is not immediately issued to the custodian. The certification management system sends a notice to the custodian of a potential refusal to certify or similar message to the custodian (Block 117). The notice provides the custodian with a defined amount of time to correct the failure to send the representation of compliance for the item (Block 119). If the custodian fails to issue the representation of compliance for the item within the defined amount of time, then the certificate of loss is issued (Block 121). If the custodian is able to issue the representation of compliance within the defined amount of time, then the certificate of loss is not issued for the item. The defined amount of time can be any time range defined by the certification management system or by agreement between the owner and custodian. For example, the defined amount of time can be in the range of minutes, hours, days, weeks or longer. The certification management system can maintain a counter or similar mechanism for tracking the length of time since the notice of potential refusal to certify was issued.

In the event that any of the items, locations or terms are not present in the set of representations of compliance supplied by the custodian or do not match with the information stored in the inventory tracking database, then the certificate management system can generate a certificate of loss for each item that lacks a representation of compliance or only an imperfect non-matching representation of compliance. The certificate of loss provides a positive identification of a time when the item is lost, or the conditions under which its care were not met. Thus, in these cases the custodian has breached its obligations with the owner and the certificate of loss provides a memorialization of this event. The certificate of loss can be digitally signed by the entity providing the certification process using a digital certificate issued by a separate certification agency. This enables the certificate of loss to be authenticated at any time in the future and prevents the modification of the certificate after signing and the separate certification agency can authenticate the identity of the entity providing the primary certification process. The certificates of loss can be distributed to the owner, custodian or any other designated third party or any combination thereof (Block 123) by the certificate generated using any means of communication or conveyance.

In some embodiments, the certification process is continuous, sending updates of the work order at regular intervals (e.g., each day) and continues until there are no items in the care of a custodian. In cases where the items have been returned to the owner or a certificate of loss has been issued, a terminal certificate can also be issued indicating that the tracking process has come to a completion. The rate of the intervals can be specified on a per item, per owner or per custodian basis with any level of granularity including hourly, daily, monthly or similar intervals.

In some embodiments, the certification management system supports transfers of items from one custodian to another custodian. For example, an owner may desire to switch the storage company or service and have the transfer be direct between the companies rather than have the item returned to the owner before sending it to the new storage company. In this case, the certification system can support the transfer as a modification of the standard owner to custodian certification process. The certification management system can transfer the responsibility for providing the representation of compliance to the new custodian and issue the old custodian a terminal certificate or similar certificate indicating that the new custodian has taken responsibility for the item and the old custodian is no longer responsible for the item. The owner can be provided with the terminal certification for the old custodian and then receive the certification going forward from the certification management system for the new custodian.

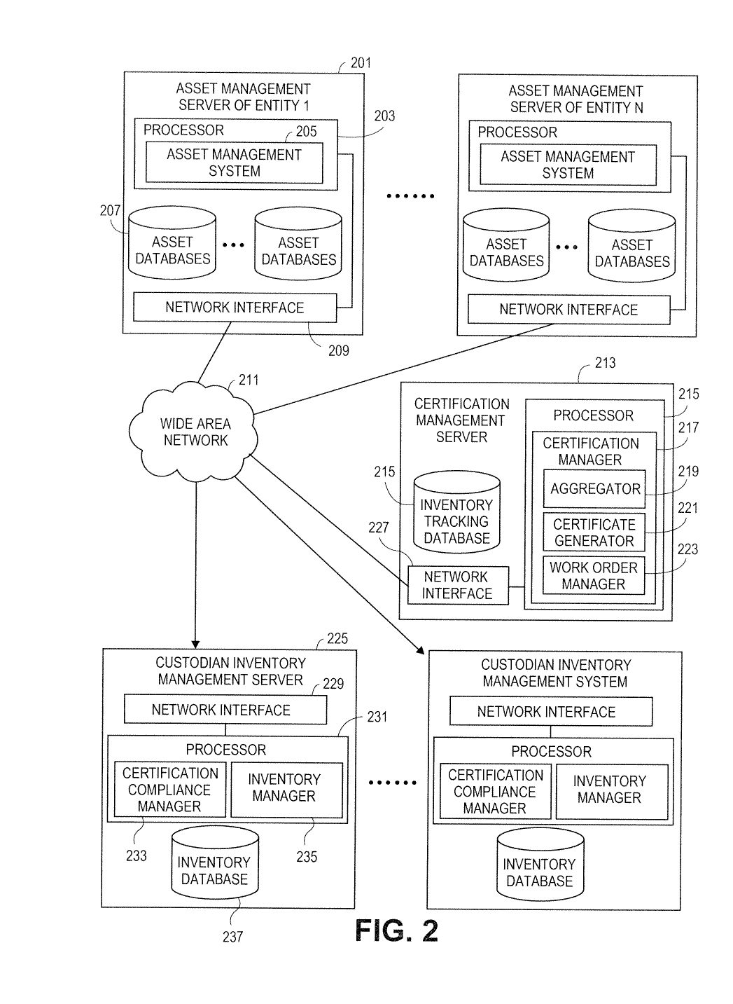

FIG. 2 is a diagram of one embodiment of certification system. The certification system encompasses the functions and communication between a set of independent computer systems including an asset management server of a first entity 201, custodian inventory management server 225 of a second entity, and a certification management server 213 of a third entity. The asset management server 201, custodian inventory management server 225 in some instances can be controlled by different departments, divisions or sub-divisions of a larger entity. Similarly, the certification management server 213 can be controlled by the same entity that controls the asset management server 201 and/or the custodian inventory management server 225. However, for sake of clarity, an example where they are independently controlled is provided herein.

The asset management server 201 can be a single server or any number of separate servers or similar computing devices capable of executing an asset management system 205 and administering an asset database 207. In some embodiments, the asset management server 201 is a distributed system with multiple machines, processors and other inter-related resources working together to provide the functions described herein as part of the asset management server 201. A processor 203 or set of processors can execute the asset management system 205, which is software that manages the asset databases 207 and manages communication with the certification manager 217 over a network interface 209 of the asset management server 201. The asset management server 201 can include any number and type of processors as well as memory devices and long term storage for executing the asset management system 205 software.

The asset databases 207 can be local to the asset management server either directly connected, connected over a local area network or similarly in communication with the asset management system 205. The asset databases 207 can have any format or organization, such as a relational database, object-oriented database or similar database organization. The asset databases 207 can track information including location and other characteristics of items owned by the entity administering the asset management server. This information can also include information about the terms of the agreement with custodians of the items when they are not in the possession of the owner. This information can be accessed and updated by the asset management system 205, which can provide a user interface and similar features for administering the asset databases 207 and implementing general asset management functions.

The network interface 209 can by any type of wired or wireless interface that allows the asset management server 201 to communicate with a certification management server 213 or custodian inventory management server 225. The asset management server 201 can include any number of network interfaces that enable communication over any number of separate communication lines, such as communication over a wide area network 211, a local area network and similar communication mediums.

Any number of separate entities and their asset management servers 201 can be serviced by a set of certification management servers 212. A ‘set,’ as used herein, refers to any positive whole number of items including one item. These asset management servers 201 can communicate over the same wide area network 211, such as the Internet, or can communicate over separate networks or private networks with a set of certification management servers 213.

The certification management server can be a single server or any number of separate servers or similar computing devices capable of executing a certification manager 217 and administering an inventory tracking database 215. In some embodiments, the certification management server 213 is a distributed system with multiple machines, processors and other inter-related resources working together to provide the functions described herein as part of the certification management server 213. A processor 203 or set of processors can execute the certification manager 217, which is software that manages the inventory tracking databases 215 and manages communication with the asset management system 205 and certification compliance manager 233 over a network interface 227 of the certification management server 213. The certification management server 213 can include any number and type of processors as well as memory devices and long term storage for executing the certification manager 215 software.

The inventory tracking database 215 can be local to the certification management server 213 either directly connected, connected over a local area network or similarly in communication with the certification management server 213. The inventory tracking database 215 can have any format or organization, such as a relational database, object-oriented database or similar database organization. The inventory tracking database 215 can track information including location and other characteristics of items for all owners that are in the possession of all custodians serviced by the certifier. This information can also include information about the terms of the agreement between the owners and the custodians of the items. This information can be accessed and updated by the certification manager 217, which can provide a user interface and similar features for administering the inventory tracking database 215 and implementing general certificate management functions.

These certificate management functions can include aggregation that is performed by an aggregator 219 in the certification manager 217. The aggregator 219 can manage the receipt, collation and storage of incoming item information and related information. The aggregator 219 can format and store the data in the inventory tracking database 215. The work order manager 223 can generate work orders from the data received by the aggregator or derived from the comparison of the received data and the inventory tracking database 215. A certificate generator 221 can receive representations of compliance from custodian inventory management systems 225 and compare them with the obligations detailed in the inventory tracking database 215, before issuing certificates for matching representations of compliance and item related obligations. The certificate generator 221 can also generate certificates of loss for those items without matching representations of compliance. The certificate generator 221 can generate terminal certificates for the completion of responsibilities by a custodian or the transfer of responsibilities between custodians. The certificate generator 221 can then distribute these certificates to the owners and custodians.

The network interface 227 can by any type of wired or wireless interface that allows the certification management server 213 to communicate with the asset management 201 or custodian inventory management system 225. The certification management server 213 can include any number of network interfaces that enable communication over any number of separate communication lines, such as communication over a wide area network 211, a local area network and similar communication mediums.

A custodian inventory management server 225 can be a single server or any number of separate servers or similar computing devices capable of executing a certification compliance manager 233 and administering an inventory database 237 via an inventory manager 235. In some embodiments, the custodian inventory management server 225 is a distributed system with multiple machines, processors and other inter-related resources working together to provide the functions described herein as part of the certification compliance manager 233. A processor 231 or set of processors can execute the certification compliance manager 233 and inventory manager, which is software that manages the reporting of representations of compliance and the inventory database 237, respectively. The certification compliance manager 233 manages communication with the certification manager 217 over a network interface 229 of the custodian inventory management server 225. The custodian inventory management server 225 can include any number and type of processors as well as memory devices and long term storage for executing the certification compliance manager 233 software.

The inventory database 237 can be local to the custodian inventory management server 225 by being either directly connected, connected over a local area network or similarly in communication with the custodian inventory management server 225. The inventory database 237 can have any format or organization, such as a relational database, object-oriented database or similar database organization. The inventory database 237 can track information including location and other characteristics of items in the possession, care or supervisions of the custodian. This information can also include information about the terms of the agreement with the owners of the items. This information can be accesses and updated by the inventory manager 235, which can provide a user interface and similar features for administering the inventory database 237 and implementing general asset management functions.

The network interface 229 can by any type of wired or wireless interface that allows the custodian inventory management server 225 to communicate with a certification management server 213 or asset management server 201. The custodian inventory management server 225 can include any number of network interfaces that enable communication over any number of separate communication lines, such as communication over a wide area network 211, a local area network and similar communication mediums.

Any number of separate entities and their custodian inventory management servers 225 can be serviced by a set of certification management servers 212. These custodian inventory management servers 225 can communicate over the same wide area network 211, such as the Internet, or can communicate over separate networks or private networks with a set of certification management servers 213. Multiple independent custodian inventory management servers 225 can be inter-operable to enable transfers of items between custodians without requiring the items to be returned to the owner.

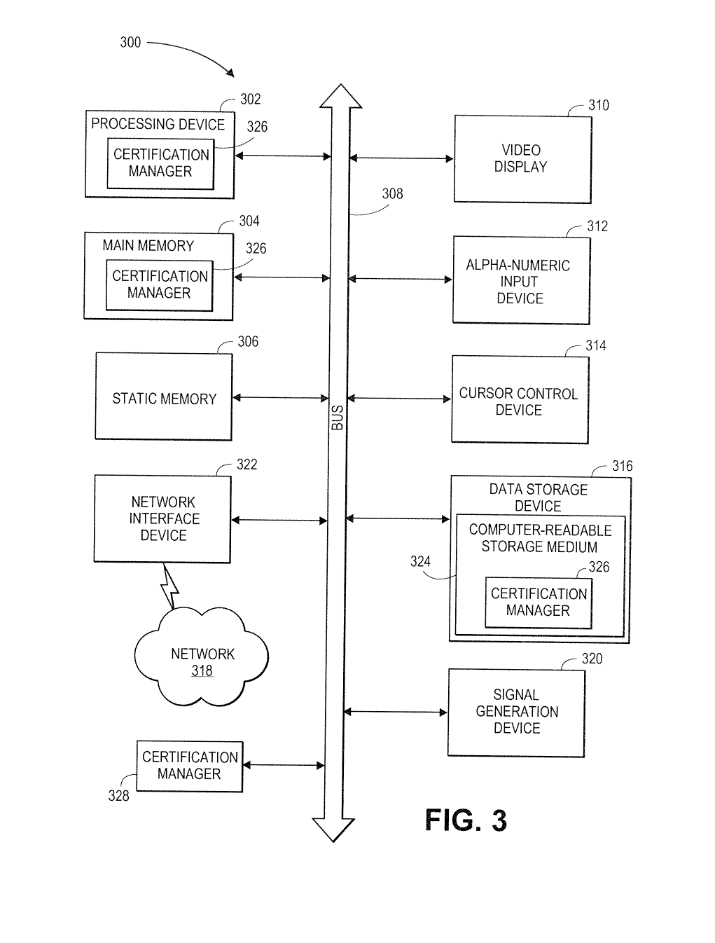

FIG. 3 illustrates a diagrammatic representation of a machine in the exemplary form of a computer system 300 (e.g., a certification management server) within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system includes a processing device 302, a main memory 304 (e.g., read-only memory (ROM), flash memory, dynamic random access memory (DRAM) such as synchronous DRAM (SDRAM) or Rambus DRAM (RDRAM), etc.), a static memory 30 (e.g., flash memory, static random access memory (SRAM), etc.), and a secondary memory 316 (e.g., a data storage device), which communicate with each other via a bus 308.

The processing device 302 represents one or more general-purpose processing devices such as a microprocessor, central processing unit, or the like. More particularly, the processing device may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processing device 302 may also be one or more special-purpose processing devices such as an application specific integrated circuit (ASIC), a field programmable gate array (FPGA), a digital signal processor (DSP), network processor, or the like. The processing device 302 is configured to execute kernel logic for performing the operations and steps discussed herein.

The computer system may further include a network interface device 322. The computer system also may include a video display unit 310 (e.g., a liquid crystal display (LCD) or a cathode ray tube (CRT)), an alphanumeric input device 312 (e.g., a keyboard), a cursor control device 314 (e.g., a mouse), and a signal generation device 320 (e.g., a speaker).

The secondary memory 316 may include a machine-readable storage medium (or more specifically a non-transitory computer readable storage medium 324) on which is stored one or more sets of instructions (e.g., the certification manager 326) embodying any one or more of the methodologies or functions described herein (e.g., the certification manager 326). The certification manager 326 may also reside, completely or at least partially, within the main memory 304 and/or within the processing device 302 during execution thereof by the computer system; the main memory and the processing device also constituting machine-readable storage media. The certification manager 326 may further be transmitted or received over a network 318 via the network interface device.

The non-transitory computer readable storage medium may also be used to store the certification manager persistently. While the non-transitory computer readable storage medium is shown in an exemplary embodiment to be a single medium, the term “non-transitory computer readable storage medium” should be taken to include a single medium or multiple media (e.g., a centralized or distributed database, and/or associated caches and servers) that store the one or more sets of instructions. The term “non-transitory computer readable storage medium” shall also be taken to include any medium that is capable of storing or encoding a set of instructions for execution by the machine that causes the machine to perform any one or more of the methodologies of the present invention. The term “non-transitory computer readable storage medium” shall accordingly be taken to include, but not be limited to, solid-state memories, and optical and magnetic media.

The computer system 302 may additionally include a hardware implemented certification manager 328 for implementing the functionalities of the certification process described above. The components and other features described herein can be implemented as discrete hardware components or integrated in the functionality of hardware components such as ASICS, FPGAs, DSPs or similar devices. In addition, the functions can be implemented as firmware or functional circuitry within hardware devices. Further, the functions can be implemented in any combination of hardware devices and software components.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “executing,” “determining,” “setting,” “receiving,” “distributing,” “generating,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A computer-implemented method comprising:
receiving an identifier of a transferred item from an asset database of an owner of the item;
updating an inventory tracking database of a certification management system to include the transferred item;
receiving a representation of compliance that the transferred item is held by a custodian from a custodian inventory management system;
generating a certificate for the item indicating that the item is held by the custodian, in response to receiving the representation of compliance; and
distributing the certificate to the owner and the custodian of the transferred item.

2. The computer-implemented method of claim 1, wherein the identifier is received from the asset database with a location identifier indicating a location to which the item was transferred.

3. The computer-implemented method of claim 1, further comprising:
generating a work order for the custodian including the identifier of the transferred item, the work order to include item identifiers for each item transferred to the custodian; and
forwarding the work order to the custodian.

4. The computer-implemented method of claim 1, further comprising:
comparing the representation of compliance with the inventory tracking database to identified matching items.

5. The computer-implemented method of claim 4, further comprising:
issuing a notice of potential refusal to certify to the custodian in response to failing to match the item with the representation of compliance; and
checking for a corrected representation of compliance within a defined time period.

6. The computer-implemented method of claim 4, further comprising:
generating a certificate of loss for the item in response to failing to match the item with the representation of compliance; and
distributing the certificate of loss to the owner and the custodian.

7. The computer-implemented method of claim 1, further comprising:
comparing the received identifier with the inventory tracking database to identify changes to the inventory tracking database.

8. The computer-implemented method of claim 7, further comprising:
receiving a listing of all items transferred by the owner; and
comparing the listing of items with the inventory tracking database to identify changes to the inventory tracking database.

9. The computer-implemented method of claim 8, further comprising:
generating a work order for the custodian including identifiers for each item in the listing of all items transferred to the database that changed, the work order to include item identifiers for each item in the listing that changed; and
forwarding the work order to the custodian.

10. The computer-implemented method of claim 8, further comprising
receiving a representation of compliance that each item in the work order is held by the custodian from the custodian inventory management system;
generating a set of certificates including a separate certificate for each item indicating that each item is held by the custodian, in response to receiving the representation of compliance; and
distributing each certificate to the owner and the custodian of each item.

11. A certification management server, comprising:
an inventory tracking database to store a set of item and location tuples that identify items that have been transferred from an owner to a custodian; and
a processor coupled to the inventory tracking database, the processor configured to execute a certificate manager, the certificate manager to receive an identifier of a transferred item from an asset database of the owner of the item, to update the inventory tracking database to include the transferred item, to receive a representation of compliance that the transferred item is held by a custodian from a custodian inventory management system, to generate a certificate for the item indicating that the item is held by the custodian, in response to receiving the representation of compliance, and to distributing the certificate to the owner and the custodian of the transferred item.

12. The certification management server of claim 11, wherein item identifier and the location identifier are received from an asset database, where the location identifier indicates a location to which the item was transferred.

13. The certification management server of claim 11, wherein the processor is further configured to execute the certificate manager to generate a work order for the custodian including the identifier of the transferred item, the work order to include item identifiers for each item transferred to the custodian, and to forward the work order to the custodian.

14. The certification management server of claim 11, wherein the processor is further configured to execute the certificate manager to compare the representation of compliance with the tracked inventory database to identified matching items.

15. The certification management server of claim 14, wherein the processor is further configured to execute the certificate manager to issue a notice of potential refusal to certify to the custodian in response to failing to match the item with the representation of compliance, and to check for a corrected representation of compliance within a defined time period.

16. The certification management server of claim 15, wherein the processor is further configured to execute the certificate manager to generate a certificate of loss for the item in response to failing to match the item with the representation of compliance and to distribute the certificate of loss to the owner and the custodian.

17. The certification management server of claim 11, wherein the processor is further configured to execute the certificate manager to compare the received identifier with the tracked inventory database to identify changes to the tracked inventory database.

18. The certification management server of claim 17, wherein the processor is further configured to execute the certificate manager to receive a listing of all items transferred by the owner, and to compare the listing of items with the tracked database to identify changes to the tracked inventory database.

19. The certification management server of claim 18, wherein the processor is further configured to execute the certificate manager to generate a work order for the custodian including identifiers for each item in the listing of all items transferred to the database that changed, the work order to include item identifiers for each item in the listing that changed, and to forward the work order to the custodian.

20. The certification management server of claim 18, wherein the processor is further configured to execute the certificate manager to receive a representation of compliance that each item in the work order is held by the custodian from the custodian inventory management system, to generate a set of certificates including a separate certificate for each item indicating that each item is held by the custodian, in response to receiving the representation of compliance, and to distribute each certificate to the owner and the custodian of each item.
